(19) United States
(12) Patent Application Publication
(10) Pub. No.: US 2020/0143436 A1
(43) Pub. Date: May 7, 2020

(54) REAL ESTATE BUYER PASSIVE FEEDBACK APPLICATION

(71) Applicant: CARRIER CORPORATION, Palm Beach Gardens, FL (US)

(72) Inventor: Tony SPATH, West Hartford, CT (US)

(73) Assignee: CARRIER CORPORATION, Palm Beach Gardens, FL (US)

(21) Appl. No.: 16/626,960

(22) PCT Filed: Jun. 18, 2018
(86) PCT No.: PCT/US2018/037998

§ 371 Date: Dec. 27, 2019

Related U.S. Application Data
(60) Provisional application No. 62/527,388, filed on Jun. 30, 2017.

(51) Int. Cl. G06Q 30/02; G06Q 50/16

(52) U.S. Cl. CPC G06Q 30/0282; G06Q 50/16; G06Q 30/0201

(57) ABSTRACT

A method to provide feedback includes sensing physical state data during a property showing of a real estate listing; analyzing the physical state data to determine an emotional state; and correlating the emotional state to feedback for the property showing.

### BACKGROUND

The present disclosure relates generally to a real estate buyer feedback system, and more particularly, to a system and method to passively determine feedback from a buyer during a home showing.

In the real estate industry, the listing agent must often, at the seller's behest, contact the showing agent to receive feedback as to the buyer's perspective on the home. This can be a time-consuming practice and can lead to seller frustration in understanding what actions may facilitate sale of their home from the perspective of the buyer who views their home. In addition, prospective buyers, especially in fast markets, may have difficulty recalling their views on the multiple of properties they have seen.

### SUMMARY

A method for passively providing feedback of a buyer regarding a real estate property visited by the buyer according to one disclosed non-limiting embodiment of the present disclosure can include sensing physical state data of the buyer during a property showing of a subject real estate property; analyzing the physical state data to determine an emotional state; and correlating the emotional state to feedback for the subject real estate property showing.

A further embodiment of the present disclosure may include that the sensing the buyer's physical state data is performed with a biometric marker sensor.

A further embodiment of the present disclosure may include attaching the biometric marker sensor to a buyer.

A further embodiment of the present disclosure may include locating the biometric marker sensor in at least one room of the subject real estate property.

A further embodiment of the present disclosure may include using the physical state data to set a baseline.

A further embodiment of the present disclosure may include that analyzing the physical state data to determine the emotional state includes determining a difference from the baseline.

A further embodiment of the present disclosure may include storing the feedback in a real estate feedback application.

A further embodiment of the present disclosure may include uploading the feedback from a real estate feedback application.

A further embodiment of the present disclosure may include that sensing the physical state data includes sensing at least one of speech patterns, brainwaves, heart rate, skin temperature, eye movement, and sudden bodily movements.

A passive buyer feedback system according to one disclosed non-limiting embodiment of the present disclosure can include a biometric marker sensor; and a handheld device for operation of a real estate feedback application, the handheld device in communication with the biometric marker sensor, the real estate feedback application operable to passively determine feedback for a subject real estate property in response to a physical state data from the biometric marker sensor.

A further embodiment of the present disclosure may include a buyer server in communication with the handheld device to receive the feedback and to store the feedback in a buyer database system.

A further embodiment of the present disclosure may include a listing recommendation server in communication with the buyer server.

A further embodiment of the present disclosure may include that the biometric marker sensor is in a wearable device.

A further embodiment of the present disclosure may include that the biometric marker sensor is in at least one room of the property showing.

A method for passively determining feedback associated with a real estate listing, according to one disclosed non-limiting embodiment of the present disclosure can include receiving physical state data during a property showing of a subject real estate property; analyzing the physical state data to determine an emotional state; correlating the emotional state to feedback for the subject real estate property; and communicating the feedback from a real estate feedback application.

A further embodiment of the present disclosure may include that the receiving the physical state data includes at least one of speech patterns, brainwaves, heart rate, skin temperature, eye movement, and sudden bodily movements.

A further embodiment of the present disclosure may include that the receiving the physical state data includes receiving the physical state data with a biometric marker sensor.

A further embodiment of the present disclosure may include receiving the physical state data from biometric marker sensor in a real estate feedback application of a handheld device.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic system diagram of a real estate feedback application system.

FIG. 2 is a schematic diagram of a handheld device.

FIG. 3 is a flowchart of a method to provide feedback for real estate, with the system of FIG. 1.

FIG. 4 is a screenshot of the real estate feedback application property listing view.

FIG. 5 is a screenshot of the real estate feedback application feedback view.

FIG. 6 is a schematic diagram of a system to provide feedback for real estate which is a portion of the system of FIG. 1.

FIG. 7 is a flowchart to provide feedback from a buyer's handheld device.

FIG. 8 is a schematic block diagram of feedback provided from a buyer's handheld device to a seller

FIG. 9 is a general schematic system diagram of a passive real estate feedback application system according to one embodiment.

FIG. 10 is a schematic system diagram of a passive real estate feedback application system according to another embodiment.

FIG. 11 is a schematic block diagram of passive feedback collection.

### DETAILED DESCRIPTION

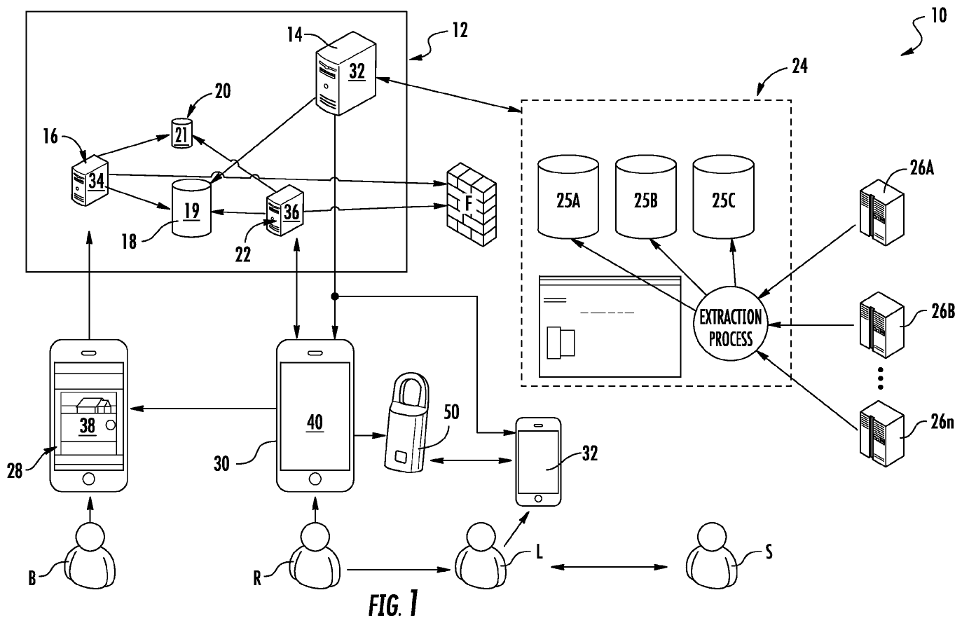

FIG. 1 schematically illustrates a system 10 to facilitate communication for real estate transactions. A property buyer “B” is typically represented by a showing agent “R” while a property seller “S” is typically represented by a listing agent “L.” The listing agent “L” communicates with the buyer “B” only indirectly, such as by communication with the showing agent “R” who then communicates information with the buyer “B.” Although only particular agents are referred to in the illustrated embodiments, the functions of such personnel may be otherwise assigned or rearranged. For example, the listing agent “L” may be a senior person in an agency who utilize a seller's assistant. The showing agent “R” may similarly utilize a showing assistant. As is discussed below, the prospective buyer “B” may wish to obtain input from third parties “T” such as family, friends, and/or others.

The system 10 generally includes a subsystem 12 that may be controlled by a single owner. The subsystem 12 generally includes a listing recommendation server 14, a buyer server 16, a buyer storage system 18, a log storage system 20, and an electronic key server 22. The listing recommendation server 14 communicates with the buyer storage system 18, the log storage system 20, and a storage system 24. The buyer storage system 18 includes a database 19 that stores, for example, feedback created by the buyer “B” (e.g., buyer feedback, third party feedback, etc.). The log storage system 20 includes a database 21 that collects activity data associated with the property showings.

The storage system 24 may include, but not be limited to, a database for managing key holders 25A, a security database 25B that hosts security protocols, and a listing database 25C that stores extracted property data from external databases 26A, 26B, 26N. The storage system 24 communicates with the external databases 26A-26N such as the Real Estate Transaction Standard (RETS) framework that stores MLS data. Communication between the various servers may include internet protocols or the like. The MLS data may include information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The national association of realtors refers to RETS as a “common language.”

A multiple of handheld devices 28, 30, 32, may communicate with the subsystem 12. For example, the handheld devices 28, 30, 32, may be a smartphone, tablet, or other mobile device of the respective individual. Handheld device 28 is used by the potential buyer “B,” handheld device 30 is used by the showing agent “R,” and handheld device 32 is used by the listing agent “L. Various other handheld devices such as those used by the third parties “T” may also be in communication with the subsystem 12 either directly or through communication with the handheld devices 28, 30, 32, as an intermediary.

Information is accessible by the listing agent “L” through the subsystem 12 so that the listing agent “L” can, for example, generate reports for their seller “S,” send updates about a particular listing to showing agents “R”, or provide feedback from a buyer “B” to their seller “S.” The subsystem 12 may also obtain information from a Real Estate Transaction Standard (RETS) framework that stores MLS data. The subsystem 12 may also obtain information generated by an electronic key box 50 that occurs as a consequence of the showing, such as number of times shown, time spent at the subject property for each showing, return showings, etc. The subsystem 12 may also be used by the listing agents “L” to receive automatic notification (e.g., email notices) when a showing occurs at their listings. The subsystem 12 may also be used by the buyer “B” as a repository for information (e.g., details of each property the buyer has viewed, feedback on the properties, etc.). The seller “S” can also receive feedback from the buyer “B” either directly from the subsystem 12, or through communications with the listing agent “L” who communicates with the subsystem 12.

The listing recommendation server 14 hosts, for example, at least an analytics software application 32 that compiles and runs analytics against buyer ratings and MLS listing data from the storage system 24. The buyer server 16 hosts a buyer application program interface (API) 34, and the electronic key server 22 hosts an electronic key API 36. An application program interface (API) may include a set of routines, protocols, and/or tools for building software applications. The API specifies how software components should interact. APIs are used when programming graphical user interface (GUI) components. A server-side web API is a programmatic interface with one or more publicly exposed endpoints to a defined request-response message system.

The listing recommendation server 14 may communicate with a real estate application 38 on the handheld device 28 through the buyer API 34. An agent application 40 on the handheld device 30 may communicate with the listing recommendation server 14 and the electronic key server 22. The buyer API 34 and the electronic key API 36 may also communicate with other external systems through a firewall “F.”

The real estate application 38 may be a mobile application on the handheld device 28 that may be used by the buyer “B” to rate the properties they have seen and, as will be further described below, receive third party feedback from third parties “T” based on the buyer “B” feedback. The real estate application 38 communicates with the buyer storage system 18 through the buyer API 34 which then stores the feedback, ratings, and notes taken by the property buyer in the database 19 of the buyer storage system 18.

The agent application 40 may be a mobile application on the handheld device 30 that may be used by the showing agent “R” to access the electronic key boxes 50 via a short distance communication standard (e.g., Bluetooth). Alternatively, or in addition, the electronic key boxes 50 may be connected (e.g., cellular) directly to the listing recommendation server 14. The electronic key API 36 of the electronic key server 22 communicates with the agent application 40 to sync activity information from the electronic key boxes 50 to the electronic key API 36 (e.g., accessed key boxes, update the count of proprietary keys generated for that particular property, create a timestamp indicating that lockbox is opened), and showing notifications (e.g., to an associated showing agent “R”).

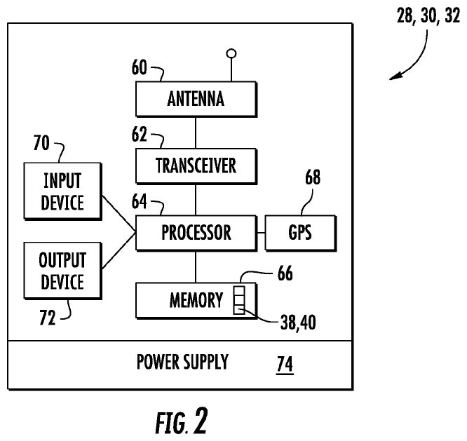

With reference to FIG. 2, each handheld device 28, 30, 32, generally includes a handheld device antenna 60, a handheld device transceiver 62, a handheld device processor 64, a handheld device memory 66, a GPS module 68, an input device 70, a display 72, and a handheld device power supply 74. The handheld device processor 64 may be any type of microprocessor having desired performance characteristics. The handheld device memory 66 may include any type of computer readable medium that stores the data and executable instructions described herein below. The executable instructions may be stored or organized in any manner and at any level of abstraction, such as in connection with one or more applications, processes, routines, procedures, methods, etc. The handheld device transceiver 62 is a transceiver of a type corresponding to the transceiver 62 and the handheld device antenna 60 is a corresponding antenna.

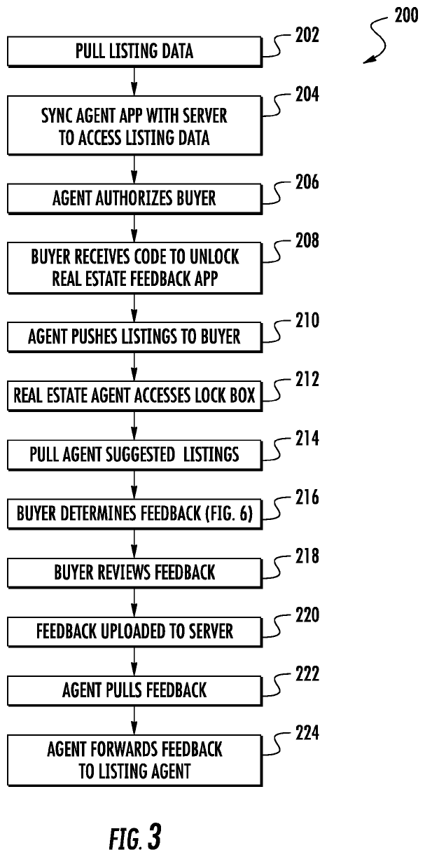

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to selectively extract (202) data such as MLS data from the external data servers 26A-26N (FIG. 1) through the listing recommendation server 14. Next, the agent application 40 syncs (204) with the listing recommendation server 14 and pulls MLS data for desired property listings of interest to the buyer “B” as, for example, selected by the showing agent “R.” This may be performed through an automated sync through the agent application 40. The showing agent “R” may also perform a manual sync to obtain the MLS data.

Through the agent application 40, the showing agent “R” can then authorize (206) the property buyer “B” to access the desired property listings of interest to the buyer “B.” Through the agent application 40, the showing agent “R” may, for example, authorizes the buyer “B” through input of buyer identification information (e.g., buyer name and email address.) The buyer identification information is then communicated to the listing recommendation server 14 so that the listing recommendation server 14 communicates the buyer “B” (e.g., via email to provide a link to an app store) with a code to unlock (208) the real estate application 38. The buyer “B” is then authorized to download the real estate application 38 and the desired property listings of interest to the buyer “B,” to maintain the value of the showing agent “R” in the real estate transaction. Alternatively, the buyer “B” already has the real estate application 38 and the desired property listings of interest to the buyer “B” are readily received.

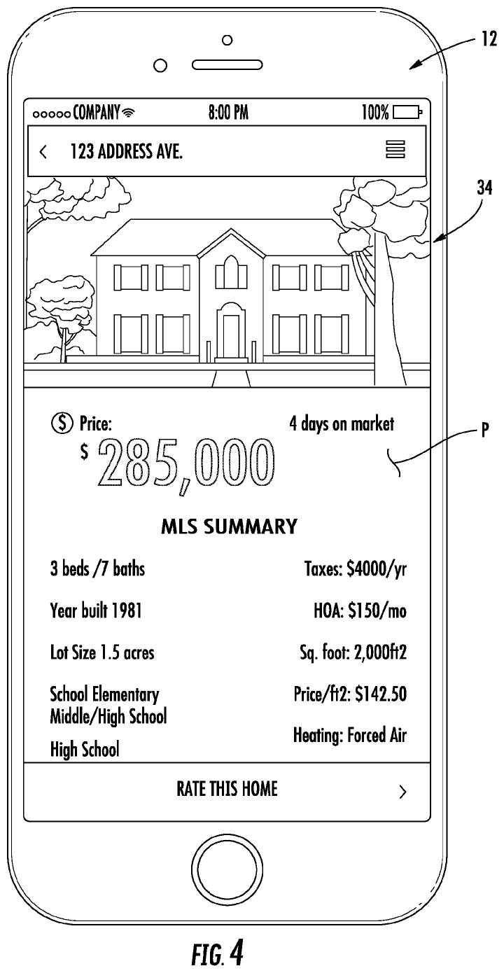

Through the agent application 40, the showing agent “R” can continue to push (210) property listings to the real estate application 38. Access may be provided for one or more properties by a showing code, or other information that unlocks one or more modules in the real estate application 38. The modules may include features or other aspects that are particular tailored to certain parties in the real estate transaction. The showing agent “R” is able to selectively push the desired property listings of interest to the buyer “B” (one example property listing illustrated by screenshot “P”; FIG. 4) through the subsystem 12 to be viewable within the real estate application 38. The showing agent “R” also uses the agent application 40 to operate the electronic key box 50 to access the property for showing to the buyer “B.”

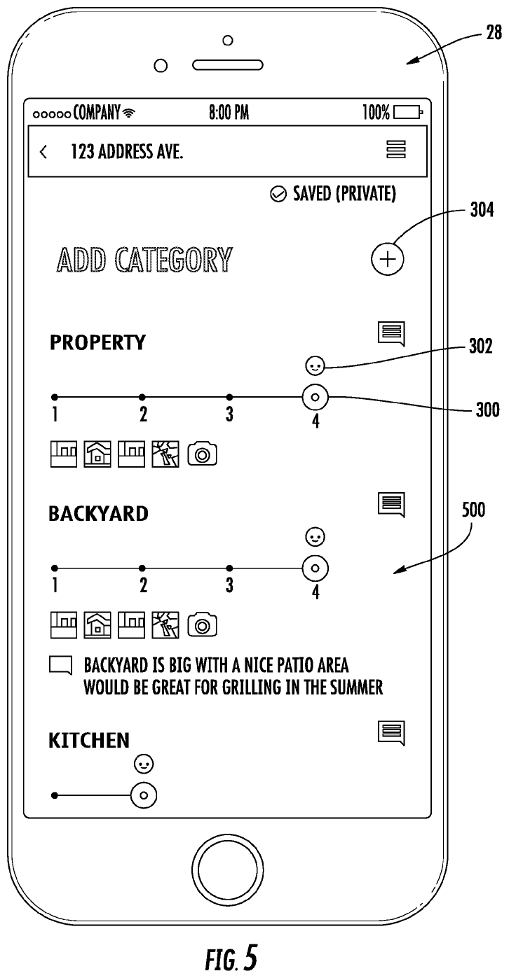

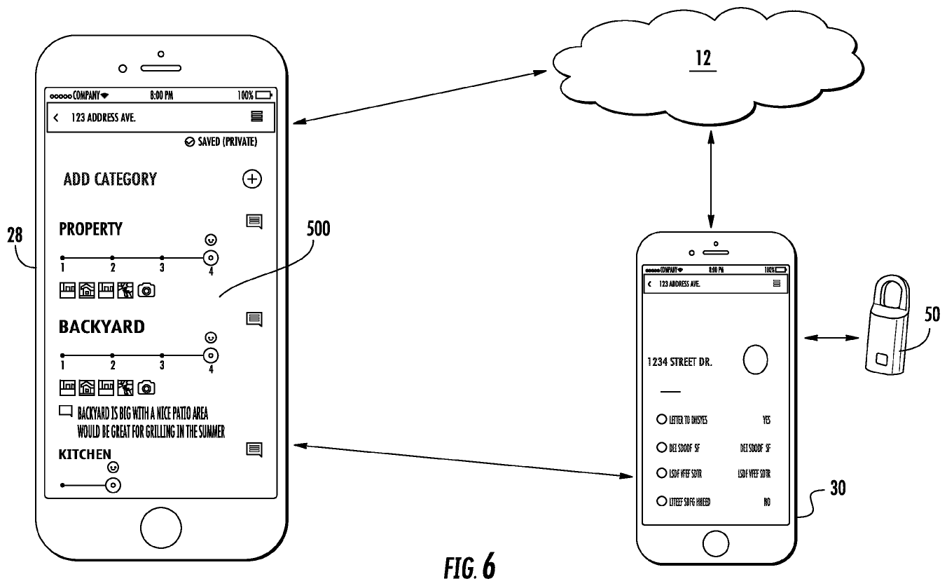

Next, during the showing, feedback is entered into the real estate feedback application 500 by the buyer “B” for the property (216; FIG. 5 and FIG. 6) as further discussed below. The feedback may include any data associated with the properties that may, for example, facilitate reviewing and comparing properties. The real estate feedback application 500 may be a module of the real estate application 38, and/or other application.

In addition to the features discussed above, the buyer “B” can utilize the real estate feedback application 500 to record feedback for each property visited. In one or more embodiments, the buyer “B” can take pictures, videos, and/or notes during the property showing. In one or more embodiments, the feedback may be provided as a scale rating (FIG. 5). For example, the scale rating may be numeric 300 (e.g., 1-10), emoji based 302 (e.g., happy face, sad face), color coded (e.g., red, yellow, green), or other such ranking. Further, the rating may be specific to particular areas of the property, (e.g., backyard, kitchen, etc.) and/or features, (e.g., appliances, fixtures, etc.). In one or more embodiments, the buyer “B” is prompted for feedback. In one or more embodiments, the buyer is prompted for feedback based on the location of the buyer within the property (e.g., via global positioning of the buyer within the property by way of the GPS module 68 (FIG. 2)) such that when the buyer enters, for example, the kitchen, the real estate feedback application 500 prompts the buyer for feedback on the kitchen, etc. In one or more embodiments, the buyer can add a category 304 to provide feedback thereon (e.g., garage).

The feedback is then saved in memory 66 (FIG. 2) via the real estate feedback application 500 so that the buyer can review at a later time (218). The feedback can also be used to compare properties reviewed by the buyer. As the buyer generates feedback about the property, the real estate feedback application 500 may also upload the feedback to the buyer storage system 18 via the buyer API 34 (220; FIG. 1). Once the showing is complete, the buyer “B” can choose to selectively share the feedback with their showing agent “R” via the real estate feedback application 500 which, in response, authorizes the listing recommendation server 14 to release the feedback from the buyer storage system 18. The agent application 40 then syncs with the listing recommendation server 14 and downloads the feedback (222). The showing agent “R” is then able to review the feedback on the agent application 40.

Through the agent application 40, the showing agent “R” can communicate the feedback to the listing agent “L” (224). In one or more embodiments, the feedback may be forwarded through an email app, text messaging app, social media, or other app on the handheld device 30, and need not be through the subsystem 12. For example, an email app resident on the handheld device 30 is called by the agent application 40, and the feedback is automatically copied into the email by the agent application 40. The showing agent “R” may then edit the email prior to sending the feedback to the listing agent “S.”

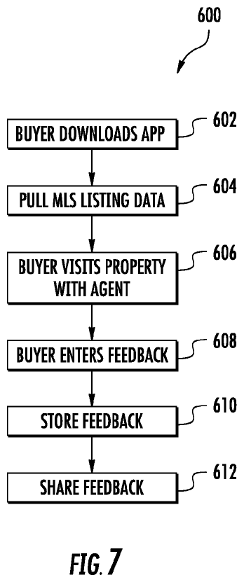

With reference to FIG. 7, a method 600 for providing feedback via the real estate feedback application 500 from the perspective of the buyer “B” is disclosed in terms of functional block diagrams. The functions are programmed software routines and executable instructions capable of execution in various microprocessor based electronics control embodiments and represented herein as block diagrams.

Initially, the buyer “B” downloads (602) the real estate feedback application 500 from a source such as an app store. The real estate feedback application 500 communicates (604) with the listing recommendation server 14 via the buyer API 34 to pull the agent selected MLS listings. The showing agent “R” then typically escorts the buyer “B” for a showing of particular properties selected by the buyer (606). Next, during the showing, the buyer “B” enters (608; FIG. 5) the feedback into the real estate feedback application 500. The real estate feedback application 500 then saves the feedback for retrieval at a later time (610). The buyer “B” can then utilize the real estate feedback application 500 to review the feedback and compare notes on the properties.

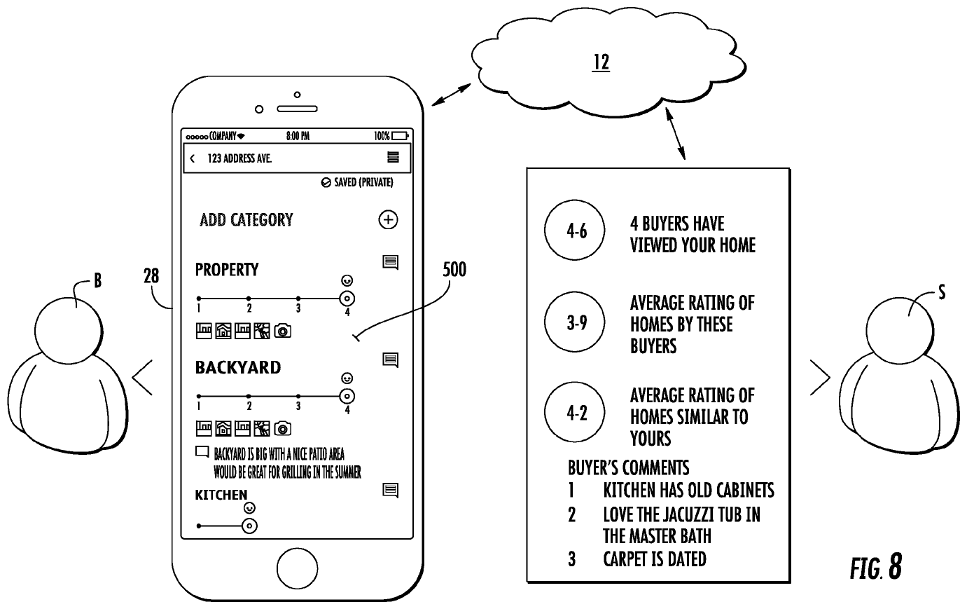

Once the showing is complete, the buyer can choose to share the ratings with their showing agent “R” (612). If they so choose, the real estate feedback application 500 will send a message to the listing recommendation server 14 though the buyer API 20 to release the ratings to the showing agent “R.” The feedback may be provided to the listing agent “L” through the subsystem 12. In this embodiment, the real estate feedback application 500 uploads the feedback data from the buyer database 18 to the electronic key server 22 via the buyer API 34 which then generates a report for the listing agent “L” (FIG. 8). The feedback report may include, but is not limited to, the buyer's feedback on the subject property, the buyer's feedback on the subject property compared to other properties, the buyer's interest in the subject property compared to other buyers' interest in the subject property by other buyers, other properties which may be comparable to the subject property based on the buyer's feedback, etc.

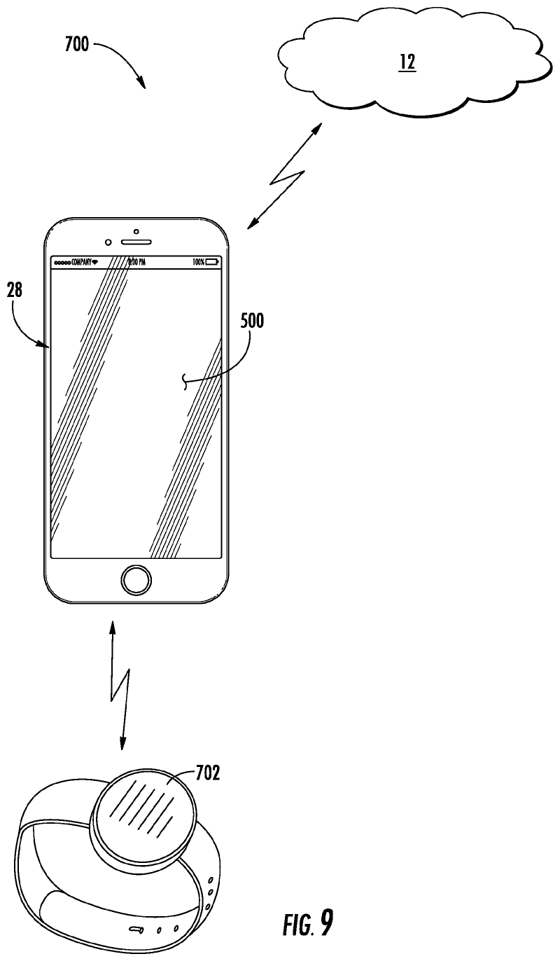

With reference to FIG. 9, in another embodiment, a passive buyer feedback system 700 generally includes a biometric marker sensor 702 that senses a buyer's physical state data during a property showing. Example biometric markers identifiable by the biometric marker sensor 702 include, but are not limited to, speech patterns, brainwaves, heart rate, skin temperature, eye movements, sudden bodily movements, or any commonly known physical response indicative of a change in emotions. This may be compared against a baseline as described below. During the property showing, as the buyer “B” walks from room to room the physical response of the buyer “B” will be correlated to a ranking for that particular room.

In one embodiment, the biometric marker sensor 702 may be a personal electronic device such as a tablet, smart phone, or wearable device (e.g., a watch, eyeglasses, etc.). That is, the biometric marker sensor 702 is a device that may be carried or worn by the buyer “B.” The biometric marker sensor 702 may be in communication with the real estate feedback application 500 on the buyer handheld device 28 via various types of wireless data communication protocols for communication. The handheld device then communicates with the subsystem 12, e.g., Bluetooth™ and/or other short range wireless technology standards to exchange data.

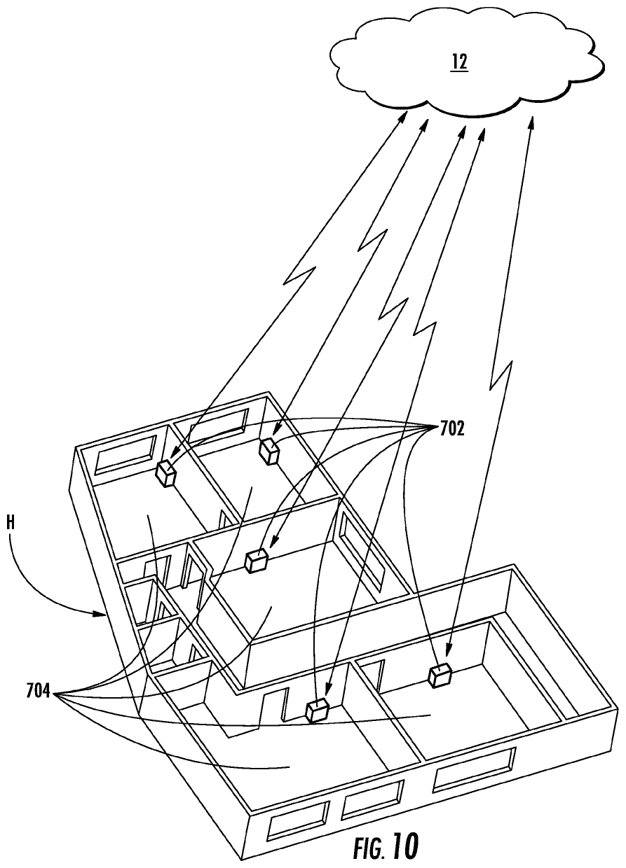

With reference to FIG. 10, in another alternate embodiment, the biometric marker sensor 702 may be in a device 704 located in one or more areas of the subject property “H” that can remotely read biometric markers of the adjacent buyer “B” as the buyer “B” tours the subject property.

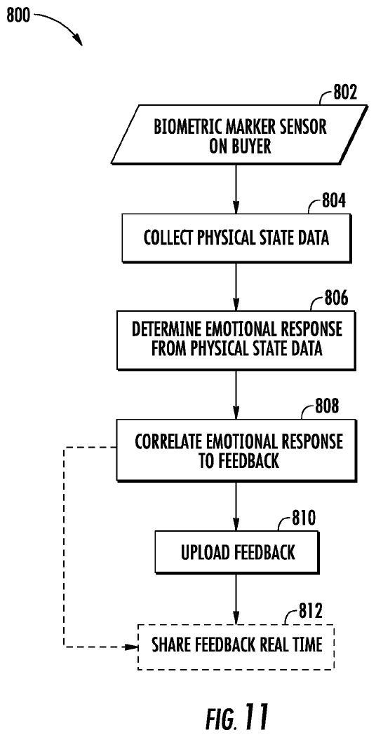

With reference to FIG. 11, a method 800 for providing passive feedback via the real estate feedback application 500 from the perspective of the buyer “B” is disclosed in terms of functional block diagrams. The functions are programmed software routines and executable instructions capable of execution in various microprocessor based electronics control embodiments and represented herein as block diagrams.

Initially, the biometric marker sensor 702 is already on the buyer “B” (802) and in communication with the real estate feedback application 500, or is given to the buyer “B” to wear for the duration of the showing. The showing agent “R” then typically escorts the buyer “B” for a showing of particular properties selected by the buyer.

Next, changes in the buyer's “B” physical state data is passively collected (804) via the biometric marker sensor 702. The physical state data may initially be communicated and stored in the handheld device memory 66. The real estate feedback application 500 utilizes the initial physical state data to determine a baseline such that changes from the baseline may be utilized to correlate a reaction to the subject property. The passive collection may initially establish the baseline based on a normal state of the buyer “B,” (e.g., resting or prior collected physical state data parameters).

Next, the changes in physical state data (e.g., from the baseline) is analyzed by the real estate feedback application 500 to determine (806) emotional responses and thus feedback which can be untiled to determine the interest of the buyer “B” to the subject property. During the property showing, as a buyer “B” walks from room to room, the emotional response will then be correlated (808) by the real estate feedback application 500 to a feedback for that particular room. The feedback is then uploaded (810) as feedback from the real estate feedback application 500 through the buyer API 34 for storage in the buyer database system 18 (FIG. 1). That is, if a user's emotions change as they walk through the house as compared to their historical baseline, it may be indicative of how they feel about the subject property which is then converted to feedback.

An example of this may be the change in a buyer's body temperature over a finite period of time. When uncomfortable or anxious a person's body temperature may rise. These changes in body temperature may be correlated to a scale such as: greater or equal to plus or minus 1 percent % change in body temperature per 15 minutes time spent at property equals uncomfortable; greater or equal to plus or minus 0.5 percent % change in body temperature per 15 minutes time spent at property equals normal; greater or equal to plus or minus 0 percent % change in body temperature per 15 minutes time spent at property equals comfortable. Uncomfortable; normal; and comfortable could then be correlated to feedback scores of the property.

In one embodiment, the feedback can be optionally shared (810) with their showing agent “R” though the buyer API 20. The feedback, in one embodiment, can be the raw emotional data in real time so that the showing agent “R” obtains perspective on the buyer “B” while showing the home.

Decisions are often based on both logic and emotion. By capturing the physical response of the buyer “B” during the property showing the passive buyer feedback system 700 compares both logical and emotional views on the subject property. Additionally, the passive buyer feedback system 700 is a relatively passive way for a buyer “B” to provide feedback that requires essentially no effort.

The elements described and depicted herein, including in flow charts and block diagrams throughout the figures imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A method for passively providing feedback of a buyer regarding a real estate property visited by the buyer, comprising:
sensing physical state data of the buyer during a property showing of a subject real estate property;
analyzing the physical state data to determine an emotional state; and
correlating the emotional state to feedback for the subject real estate property showing.

2. The method as recited in claim 1, wherein the sensing the buyer's physical state data is performed with a biometric marker sensor.

3. The method as recited in claim 2, further comprising attaching the biometric marker sensor to a buyer.

4. The method as recited in claim 2, further comprising locating the biometric marker sensor in at least one room of the subject real estate property.

5. The method as recited in claim 1, further comprising using the physical state data to set a baseline.

6. The method as recited in claim 5, wherein analyzing the physical state data to determine the emotional state includes determining a difference from the baseline.

7. The method as recited in claim 1, further comprising storing the feedback in a real estate feedback application.

8. The method as recited in claim 1, further comprising uploading the feedback from a real estate feedback application.

9. The method as recited in claim 1, wherein sensing the physical state data includes sensing at least one of speech patterns, brainwaves, heart rate, skin temperature, eye movement, and sudden bodily movements.

10. A passive buyer feedback system, comprising:
a biometric marker sensor; and
a handheld device for operation of a real estate feedback application, the handheld device in communication with the biometric marker sensor, the real estate feedback application operable to passively determine feedback for a subject real estate property in response to a physical state data from the biometric marker sensor.

11. The system as recited in claim 10, further comprising a buyer server in communication with the handheld device to receive the feedback and to store the feedback in a buyer database system.

12. The system as recited in claim 11, further comprising a listing recommendation server in communication with the buyer server.

13. The system as recited in claim 10, wherein the biometric marker sensor is in a wearable device.

14. The system as recited in claim 10, wherein the biometric marker sensor is in at least one room of the the property showing.

15. A method for passively determining feedback associated with a real estate listing, comprising:
receiving physical state data during a property showing of a subject real estate property;
analyzing the physical state data to determine an emotional state;
correlating the emotional state to feedback for the subject real estate property; and
communicating the feedback from a real estate feedback application.

16. The method as recited in claim 15, wherein the receiving the physical state data includes at least one of speech patterns, brainwaves, heart rate, skin temperature, eye movement, and sudden bodily movements.

17. The method as recited in claim 15, wherein the receiving the physical state data includes receiving the physical state data with a biometric marker sensor.

18. The method as recited in claim 17, further comprising receiving the physical state data from biometric marker sensor in a real estate feedback application of a handheld device.
